(19) United States
(12) Patent Application Publication
(10) Pub. No.: US 2009/0326938 A1
(43) Pub. Date: Dec. 31, 2009

(54) MULTIWORD TEXT CORRECTION

(75) Inventors: Juha Eerik Marila, Harjavalta (FI); Janne Vainio, Pirkkala (FI); Hannu Mikkola, Tampere (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/128,119

(22) Filed: May 28, 2008

(51) Int. Cl. G10L 15/26

(52) U.S. Cl. 704/235; 704/E15.043

(57) ABSTRACT

A method including detecting a selection of a plurality of erroneous words in text presented on a display of a device, in an automatic speech recognition system, receiving sequentially dictated corrections for the selected erroneous words in a single, continuous operation where each dictated correction corresponds to at least one of the selected erroneous words, and replacing the plurality of erroneous words with one or more corresponding words of the dictated corrections where each erroneous word is matched with the one or more corresponding words of the dictated corrections in an order the erroneous words appear according to a reading direction of the text.

### BACKGROUND

1. Field

The disclosed embodiments generally relate to user interfaces and, more particularly to user interfaces including speech recognition.

2. Brief Description of Related Developments

Automatic speech recognition can be used in a variety of devices to enter text electronically by dictating the desired text. Depending on, for example, the speech recognition algorithm, the speaker's voice and the environmental conditions surrounding the speaker, the text recognition accuracy can range anywhere from zero to one-hundred percent for any given word, sentence or paragraph. The errors introduced in the speech recognition process generally take the form of, for example, wrong words, extra words or missing words in the resulting text. While the dictation of the desired text may be reasonably fast and effortless, the correction of the incorrect words in the resulting text is generally time consuming and tedious.

Generally the correction of the incorrect text occurs one word at a time, one character at a time or by correcting a string of adjacent text (e.g. text arranged one after another in a continuous string such as the words of a sentence). Generally the corrections are made by manually (e.g. through a keyboard or other physical input) retyping the incorrect text, selecting a better candidate for the intended text from a menu or through speech recognition by re-dictating the incorrect text. Generally for non-adjacent text, the correction algorithm must be restarted for each non-adjacent text, which makes correction of non-adjacent text repetitive, tedious and time consuming.

It would be advantageous to quickly and efficiently correct non-adjacent pieces of text that are input with automatic speech recognition.

### SUMMARY

The aspects of the disclosed embodiments are directed to a method including detecting a selection of a plurality of erroneous words in text presented on a display of a device, in an automatic speech recognition system, receiving sequentially dictated corrections for the selected erroneous words in a single, continuous operation where each dictated correction corresponds to at least one of the selected erroneous words, and replacing the plurality of erroneous words with one or more corresponding words of the dictated corrections where each erroneous word is matched with the one or more corresponding words of the dictated corrections in an order the erroneous words appear according to a reading direction of the text.

In another aspect, the disclosed embodiments are directed to a computer program product stored in a memory. The computer program product includes computer readable program code embodied in a computer readable medium for detecting a selection of a plurality of erroneous words in text presented on a display of a device, in an automatic speech recognition system, sequentially receiving a dictated correction for the selected erroneous words in a single, continuous operation where each dictated correction corresponds to at least one of the selected erroneous words, and replacing the plurality of erroneous words with one or more corresponding words of the dictated corrections where each erroneous word is matched with the one or more corresponding words of the dictated corrections in an order the erroneous words appear according to a reading direction of the text.

Other aspects of the disclosed embodiments are directed to an apparatus including a display and a processor configured to detect a selection of a plurality of erroneous words in text presented on the display, receive, through an automatic speech recognition module, sequentially dictated corrections for the selected erroneous words in a single, continuous operation where each dictated correction corresponds to at least one of the selected erroneous words, and replace the plurality of erroneous words with one or more corresponding words of the dictated corrections where each erroneous word is matched with the one or more corresponding words of the dictated corrections in an order the erroneous words appear according to a reading direction of the text.

Still other aspects of the disclosed embodiments are directed to a user interface including a display configured to display computer readable text, at least one input device configured to receive sequentially dictated corrections through automatic speech recognition for replacing a plurality of selected erroneous words in a single, continuous operation where each dictated correction corresponds to at least one of the selected erroneous words, and a processor being configured to detect a selection of the plurality of erroneous words in the computer readable text presented on the display, and replace the plurality of erroneous words with one or more corresponding words of the dictated corrections where each erroneous word is matched with the one or more corresponding words of the dictated corrections in an order the erroneous words appear according to a reading direction of the text.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates a flow diagram according to aspects of the disclosed embodiments;

FIGS. 3A-3C illustrate exemplary screen shots according to aspects of the disclosed embodiments;

FIGS. 4A-4C illustrate other exemplary screen shots in accordance with aspects of the disclosed embodiments;

FIGS. 5A and 5B are illustrations of exemplary devices that can be used to practice aspects of the disclosed embodiments;

FIG. 6 illustrates a block diagram of an exemplary system incorporating features that may be used to practice aspects of the disclosed embodiments; and

FIG. 7 is a block diagram illustrating the general architecture of an exemplary system in which the devices of FIGS. 5A and 5B may be used.

### DETAILED DESCRIPTION OF THE EMBODIMENT(s)

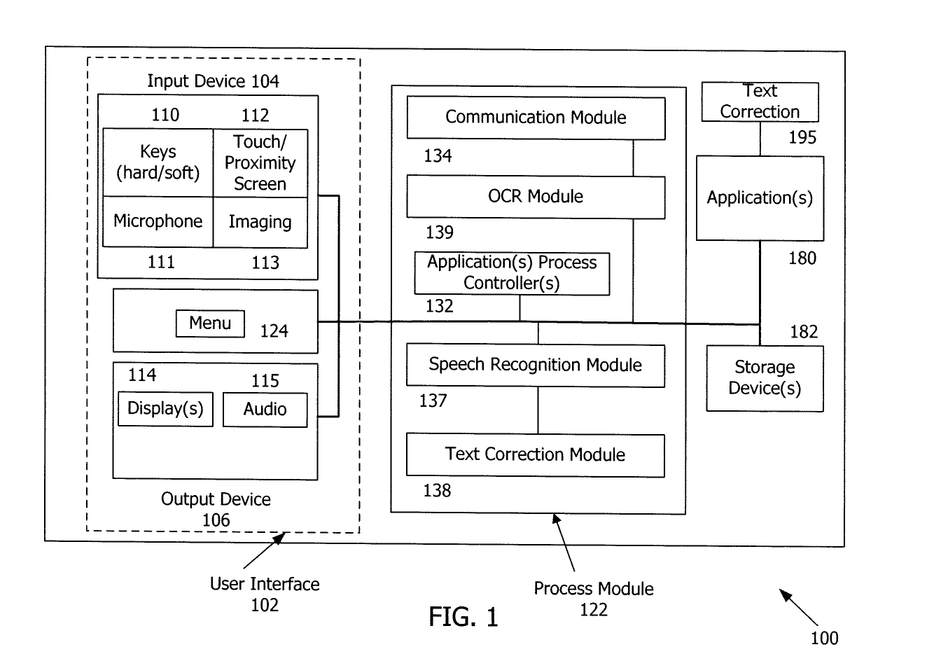

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments provide for the correction of adjacent text or words (e.g. pieces of text located next to each other) and non-adjacent text or words (e.g. incorrect text separated by correct text) in transcribed text that is entered into, for example, the system 100, through automatic speech recognition. Aspects of the disclosed embodiments also allow for the correction of adjacent or sequential text. The text corrections can be made quickly and efficiently by selecting all of the text to be corrected in the transcribed text and correcting the text in one operation or instance, as will be described in greater detail below. The aspects of the disclosed embodiments substantially eliminate repeating a correction task for each and every non-adjacent piece of text such that the automatic speech recognition feature of the system 100 is activated but one time for correcting all of the incorrect text in the transcribed text irrespective of the number of corrections performed.

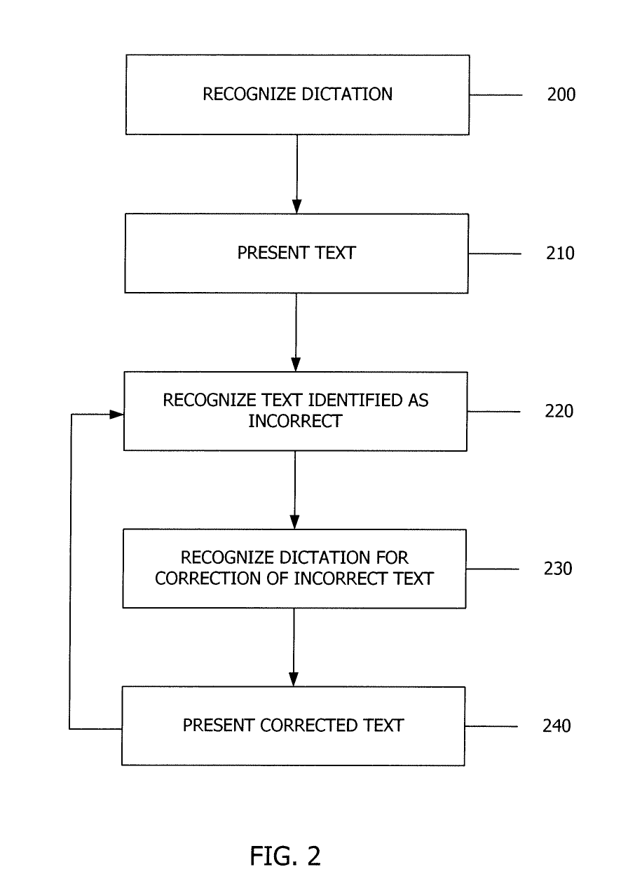

In accordance with aspects of the disclosed embodiments, the system may include a speech recognition module 137, a display 114 and a touch/proximity screen 112 (referred to herein generally as a touch screen) or any other suitable input device. The speech recognition module 137 may be configured for continuous speech recognition. The speech recognition module 137 may include any suitable speech recognizer that may include algorithms for reducing the error rate of the speech recognition module including, but not limited to, background noise reduction and speech training features. Referring also to FIG. 2, in one embodiment the user of the system 100 may activate the speech recognition module 137 in any suitable manner. For example, the speech recognition may be activated when a predetermined application including, but not limited to, email, text messaging and word processing applications, is opened. In other embodiments the voice recognition module 137 may be activated through a corresponding menu selection such that when the speech recognition is activated an associated application, such as those noted above, are also opened. A user may be able to associate the speech recognition with one or more program applications in any suitable manner such as through, for example, a menu 124 of the system 100.

The user may dictate any desired text into the system 100 using, for example, microphone 111 or any other suitable input device. In other embodiments the system 100 may acquire the text in any suitable manner including, but not limited to, electronic file/data transfers, creation in word processing documents or in any other manner such that the text is computer readable text. The text may be stored in a memory 182 of the system 100 or accessed remotely by the system. As used in the disclosed embodiments, the term “word” includes, but is not limited to, one or more individual characters or strings of characters (including, but not limited to, e.g. numbers, letters and symbols) and the term “text” includes, but is not limited to, individual words, one or more strings of words, or phrases. In this example, the dictated text is recognized and transcribed by, for example, the speech recognition module 137 in any suitable manner (FIG. 2, Block 200). The transcribed text is presented to the user through any suitable display of the system such as, for example, display 114 (FIG. 2, Block 210). In other embodiments the transcribed text may also be audibly presented to the user through, for example, an audio feature 115 of the system such as a loud speaker or headset. The user may review the transcribed text for any incorrect text or text that the user would, for any suitable reason, like to change (collectively referred to herein as incorrect text). The incorrect text may be selected by the user and indicated as being incorrect in any suitable manner. For example, the incorrect text may be selected through a touch/proximity device, keys of the system, and/or through speech recognition. The selected text may be indicated by, for example, highlighting the incorrect text, placing a box around the incorrect text and/or making a strike through the incorrect text. The text indicated as being incorrect is recognized by the system 100 (FIG. 2, Block 220). The speech recognition module 137 is reactivated and the user dictates the intended correction for the incorrect text(s). According to the aspects of the disclosed embodiments, all of the text corrections are made with one activation of the speech recognition module as will be described in greater detail below so that the user does not have to initiate a text correction sequence for each and every incorrect text. The speech recognition module 137 recognizes and transcribes the dictated corrections (FIG. 2, block 230). The system 100 is configured to replace the incorrect text with a corresponding one of the transcribed corrections and to present the corrected text to the user (FIG. 2, Block 240). The text correction can be repeated any suitable number of times to correct or change the transcribed text for any suitable reason.

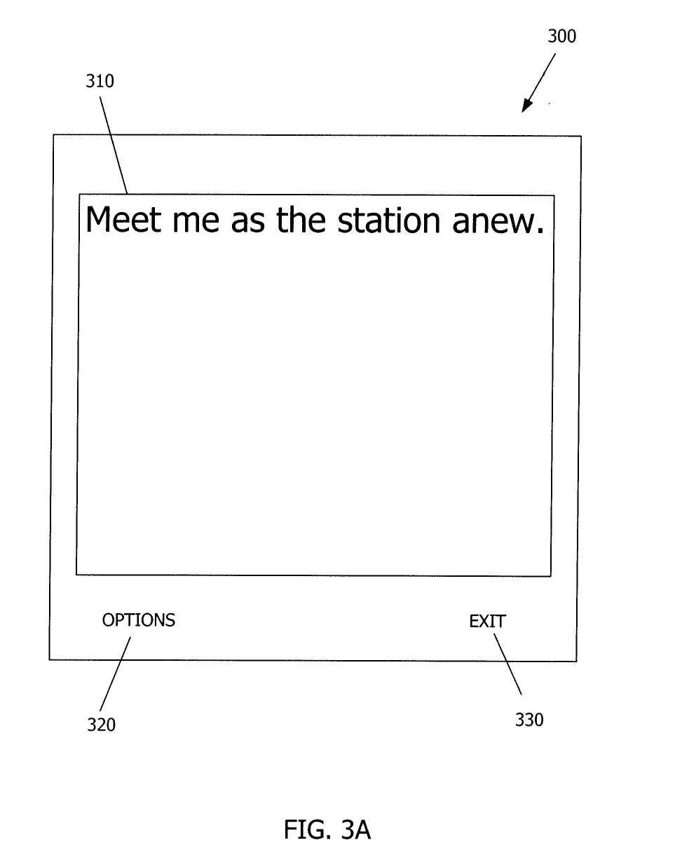

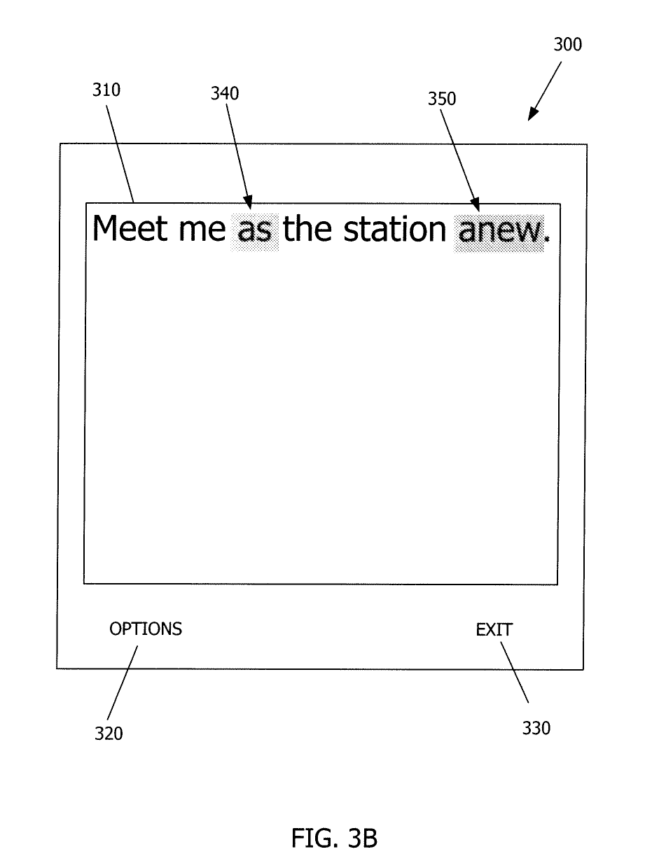

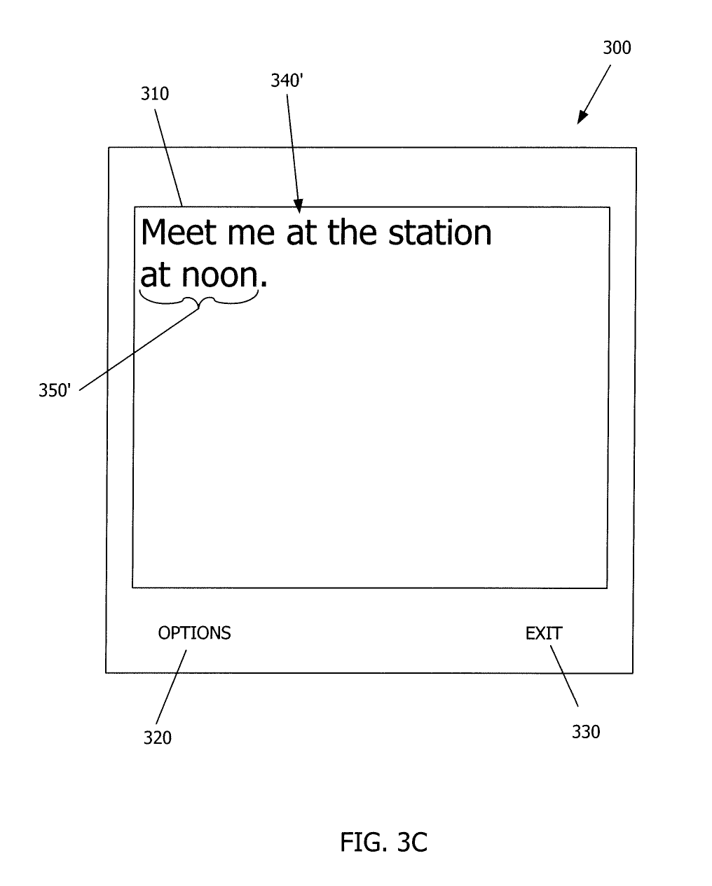

Referring to FIGS. 3A-3C examples of text correction in accordance with aspects of the disclosed embodiments will be described. As can be seen in FIG. 3A, an exemplary display 300 is shown. The display 300 includes at least a text display area 310. The display 300 may also include any other suitable items including, but not limited to, an options soft key 320 and an exit soft key 330. The options soft key 320 may allow for the configuration of, for example, the text correction module 138 and/or text correction application 195 and how the corrections are applied to the transcribed text. The exit soft key 330 may, for example, allow the user to exit the text correction application 195 at any suitable time. As can be seen in FIG. 3A, the user dictates the intended text or phrase “Meet me at the station at noon” into the system 100 in the manner described above with respect to FIG. 2. The speech recognition module 137 transcribes the dictated text for presentation on the display 300. However, in this example, when the phrase is transcribed the speech recognition module 137 incorrectly interprets some of the words. Here, the word “at” is recognized as the word 340 “as” and the words “at noon” are recognized as the word 350 “anew”. As can be seen in FIG. 3A, the texts to be corrected (e.g. texts 340, 350) are separated by the words “the station”. These separated pieces of text are referred to herein as non-adjacent text for exemplary purposes only.

To correct these incorrect texts 340, 350 the user activates, for example, the text correction module 138 (and/or the text correction application 195 which may be part of or work in conjunction with the text correction module 138) in any suitable manner including, but not limited to, voice commands or a menu of the system such as menu 124, and the options soft key 320. In other embodiments the text correction module 138 may be activated automatically after dictation of the intended text is completed. In another example, the system 100 may query the user, through for example, a “pop up” menu after the transcribed text is presented on the display 300 for allowing the user to either accept or decline whether incorrect text is to be indicated or identified. The incorrect text is selected by the user as shown in FIG. 3B in any suitable manner. In this example, the incorrect text may be selected using, for example, a touch screen by making a strike motion (e.g. moving a pointing device over the incorrect text) through each incorrect text. Phrases and sentences can also be indicated in a similar manner such as by making a striking motion over the phrase or sentence. In other embodiments the text may be selected by tapping or otherwise touching an area of the display 114/touch screen 112 corresponding to the incorrect text where, for example, touching a part of the text selects the characters in the character sequence forming the text. For example, the user may tap the pointing device on an area corresponding to the character “a” in the text “anew” such that the system 100 causes the character string “anew” to be selected. In still other examples the incorrect text may be automatically selected and indicated through, for example, a spell/grammar check application of the system 100. In this example, the words 340, 350 identified as being incorrect words are highlighted as shown in FIG. 3B. In other examples the identified incorrect words may be presented on the display 114 in any suitable manner including, but not limited to, displaying a line through the identified pieces of text, changing a font size and/or color and outlining the texts.

In one aspect the speech recognition is activated for correcting the identified texts 340, 350 in any suitable manner. In one example the user may start the speech recognition correction in any suitable manner including, but not limited to, a voice command, selecting the speech recognition from a menu associated with the options soft key, a dedicated speech recognition key and activating any suitable predetermined application such as, for example, a spell/grammar check application. In other examples, the speech recognition correction may be initiated automatically after indication of the incorrect texts is complete. For example, the system 100 may be configured to automatically start the speech recognition correction after a predetermined time period has lapsed from the time the last text was indicated (e.g. the system waits “x” seconds to start the speech recognition correction after the last text is indicated). When the speech recognition correction is started the user dictates the intended corrections. In one embodiment, the system 100 may list the selected incorrect texts on the display 114 in the order in which they appear in the text to aid the user in making the corrections. In other embodiments, the user may be able to scroll through the text when making the corrections so the selected words can be viewed during dictation of the corrections. In this example, the intended corrections are dictated sequentially in the order the indicated text appears in the transcribed text. For example, in the English language the transcribed text is read from left to right such that the indicated texts would appear in the order “as anew”. It should be understood that the order in which the texts are dictated for correction depends on a direction that the language being inputted is read. For example, in Hebrew the intended corrections would be dictated in the order as they appear from right to left. In other examples, the intended corrections may be dictated in any suitable order or sequence.

To correct the indicated texts 340, 350 the user dictates the words “at noon”. The text correction application 195, for example, may be configured to place each recognized intended correction in place of a corresponding one of the indicated texts. In one aspect, in case of a mismatch between the number of intended corrections and the number of indicated texts such that there are more intended corrections than texts to be corrected (e.g. indicated texts) the extra intended corrections are placed after the last indicated text of the transcribed text. For example, referring to FIG. 3C, the first intended correction 340′ “at” is inserted in the transcribed text in place of the text 340 “as”. In this example, because there are more intended corrections than there are indicated texts, the intended corrections 350′ “at noon” are inserted in the transcribed text in place of the last indicated text 350 “anew” as can be seen in FIG. 3C. Where there are less intended corrections than words to be corrected, the intended corrections are applied in the order the indicated text appears in the transcribed text such that after all the intended corrections are allocated within the transcribed text the remaining indicated texts are left uncorrected. For example, if the intended corrections include only the word “at” the system 100 is configured to replace the indicated word 340 “as” with the word “at” while the indicated word 350 “anew” remains uncorrected. In other examples, when the speech recognition correction is activated the system 100 may prompt the user for each correction. As a non-limiting example, if there are three indicated texts for correction the system may prompt “correction one”, “correction two” and so on, visually through the display 114 or audibly through the audio feature 115. After each prompt the user dictates the corresponding correction. In still other examples, the user may indicate which correction is being dictated. For example, to correct the indicated texts 340 “as”, 350 “anew” the user may dictate “correction at correction at noon” where the word “correction” is an identifier recognized by the text correction module 137/text correction application 195 as a separator so that more than one text item can be inserted for any one of the indicated texts. Where the correction text is the same as the identifier (e.g. the identifier is the word “correction” and the correction text is the word “correction”) the system 100 may be configured to recognize the second instance of the word “correction” immediately following the first instance of the word “correction” as the intended correction. In other examples, there may be a “correction key” of the system 100 that the user can press or otherwise activate where the key is activated for each correction made. For example, when the speech recognition correction is activated the user presses the correction key and speaks an intended correction (which may include more than one piece of text) which replaces the first indicated text, the user presses the correction key and speaks another intended correction which replaces the second indicated text and so on such that the speech recognition remains active and the key press serves to separate the intended corrections from each other. It should be understood that the prompts and separator described herein are for exemplary purposes only and that any prompts or separators may be used. In still other embodiments, where the speech activation corrections are initiated with a spell check/grammar application, the speech recognition may remain active such that as a word or phrase is identified by the spell/grammar check application the user is prompted to dictate the intended correction.

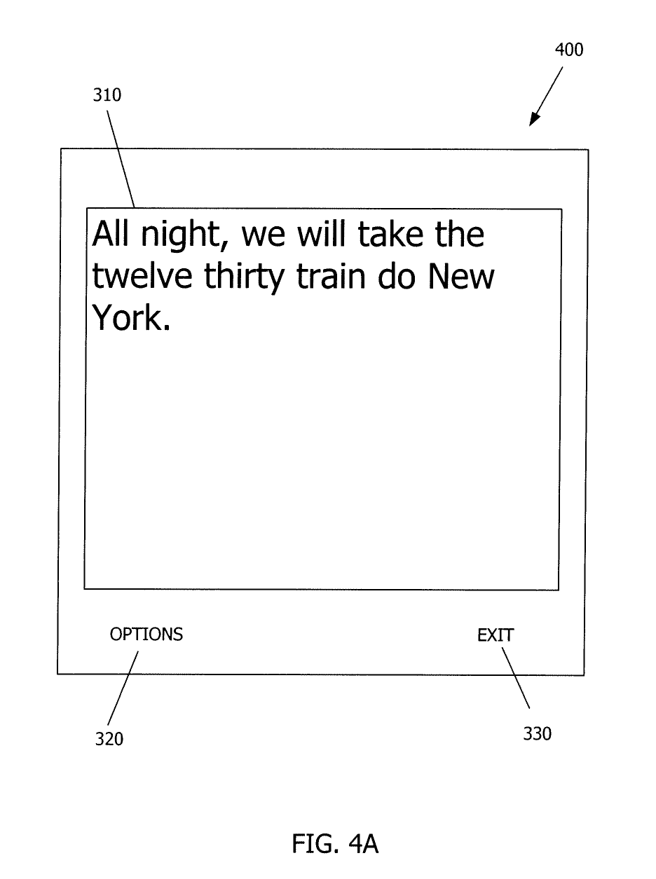

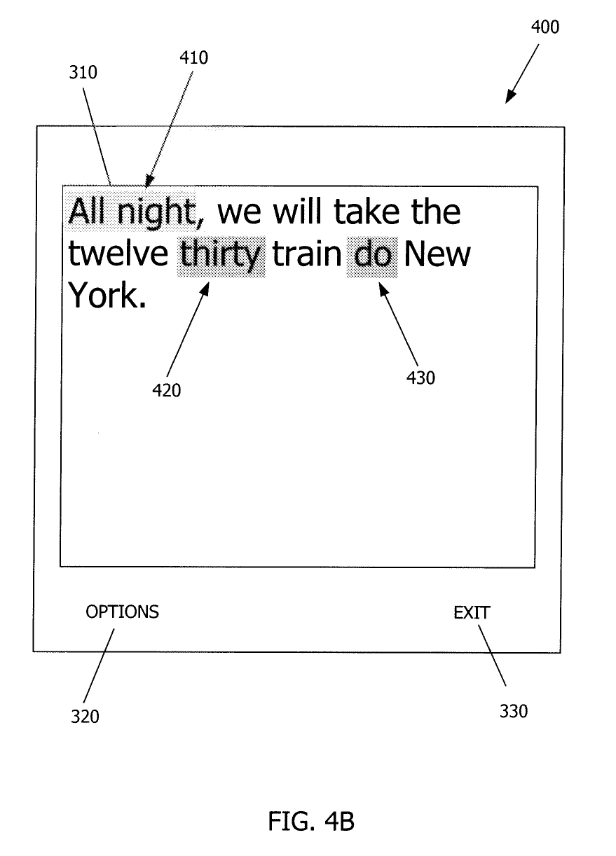

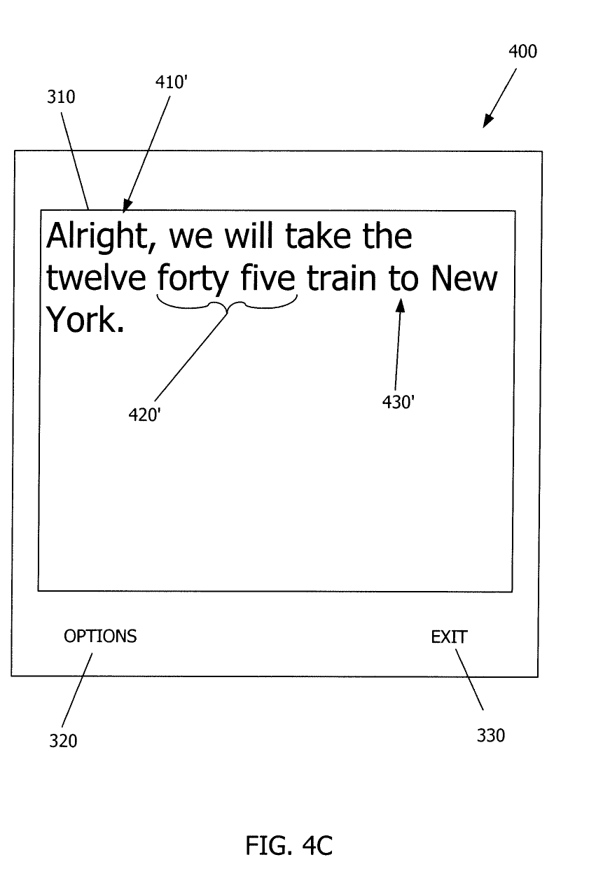

Referring now to FIGS. 4A-4C another example of text correction in accordance with aspects of the disclosed embodiments will be described. In this example, the display 400 is substantially similar to display 300 such that like features have like reference numerals, however, the transcribed text is different. In this example, the user intends to dictate the text “Alright, we will take the twelve thirty train to New York” such that the transcribed text presented on the display is that shown in FIG. 4A. In this example, as can be seen in FIG. 4B, the user indicates the incorrect text as text string 410 “All night” and text 430 “do”. The user also indicates the text 420 “thirty” for correction even though this text was correctly transcribed by the speech recognition module 137. As such, aspects of the disclosed embodiments allow a user to change text for any suitable reason including, but not limited to, the user speaking the wrong word or phrase or because the user changes his/her mind with respect to any given words or phrase(s). In a manner substantially similar to that described above with respect to FIGS. 3A-3C the text to be corrected are indicated and the speech recognition is activated. The user dictates the intended corrections as they are read from, for example, left to right as “Alright forty five to”. In this example, pieces of text, such as “All” and “night”, that are indicated together (e.g. the user passes a pointing device over two or more of the characters/words without moving the pointing device away from the touch screen) are grouped together by, for example, the text correction module 138/text correction application 195 and interpreted as a single indicated text and are replaced with the first intended correction 410′ “Alright” as shown in FIG. 4C. In other examples, pieces of text that are indicated together may not be grouped together and be replaced by sequential corrections (e.g. one correction for each indicated piece of text). In this example, the text correction module 138/text correction application 195 may be configured to recognize a context of the indicated text (e.g. whether the indicated text is a number, a hyphenated word, etc.) and compare that context to the context of the corresponding intended correction. In this example, the indicated text 420 “thirty” and the intended corrections “forty five” as can be seen in FIG. 4C are both numbers such that the system 100 recognizes the corrections “forty five” as a single intended correction 420′ for replacing the indicated word 420 “thirty” in the transcribed text. The intended correction 430 “to” replaces the indicated word 430 “do” in a manner substantially similar to that described above with respect to FIGS. 3A-3C.

In another example, still referring to FIGS. 4A-4C, the text correction module 138/text correction application 195 may be configured to compare acoustic models of the transcribed text and the intended corrections. For example, the transcribed text “All night” is acoustically similar to “Alright”. The text correction module 138/text correction application 195 may recognize this acoustic similarity and replace “All night” with Alright”. In another example, textual similarities may be used by the text correction module 138/text correction application 195 for replacing words. For example, the words “All night” and “Alright” are textually similar. This textual similarity may be recognized by the text correction module 138/text correction application 195 such that the “all night” is replaced with “Alright”.

In another example, the system 100 may include a language model (which may be part of the speech recognition and/or text correction module or any other suitable module or application of the system). The system 100 may use the language model to determine how the corrections should be applied. Still referring to FIGS. 4A-4C, the corrections 410′, 420′, 430′ may be applied in a most linguistically plausible manner according to the language model. For example, the system 100 may insert the corrections 410′, 420′, 430′ in various ways and compare the linguistics of each possible correction. In this example, the possible corrections may include a first possible correction “Alright, we will take the twelve forty five train to New York” and a second possible correction “Alright forty, we will take the twelve five train to New York. Here the first possible correction is more linguistically plausible and is chosen by the system as the corrected text shown in FIG. 4C.

The linguistic check based on the language model may also be applied when the number of selected words for correction 410, 420, 430 do not match the number of dictated corrections. In one example, referring to FIGS. 4A and 4B, the selected words for correction may exceed the number of dictated corrections. Here the selected corrections 410, 420, 430 include four (4) words. These four words may be replaced by, for example, three words such as “alright”, “fifty” and “to”. The system may replace the selected corrections 410, 420, 430 so that all the selected words are replaced. Linguistically there is one way the corrections can be inserted into the sentence such that the sentence makes sense. Accordingly the corrected sentence reads “Alright, we will take the twelve fifty train to New York.” In another example, the number of selected words for correction may be less than the number of dictated corrections. In this example, the transcribed text may read “Almighty, we will take the twelve thirty train do new York” where the words “Almighty”, “thirty” and “do” are to be corrected. The dictated corrections may include the words “alright”, “fifty”, “five” and “to”. Again the system places the dictated corrections into the sentence so that all of the selected words are replaced. This gives, for example, a first possible correction “Alright, we will take the twelve fifty train five to New York” (e.g. the extra word is inserted with the last selected word), a second possible correction “Alright fifty, we will take the twelve five train to New York” (e.g. the extra word is inserted with the first selected word) and a third possible correction “Alright, we will take the twelve fifty five train to New York” (e.g. the extra word is inserted with the second selected word). A linguistic comparison of the three possible corrections determines that the third possible correction makes the most linguistic sense such that the third possible correction is selected for when replacing the selected words. It should be understood that the specific numbers of selected words and dictated corrections described above are merely exemplary and in alternate embodiments the system is configured to replace any suitable number of selected words with any suitable number of dictated correction in a manner substantially similar to those described above.

It should also be understood that in one aspect the disclosed embodiments may also allow a user to correct any suitable number of individual characters in a manner substantially similar to those described above. For example, the user may dictate the word “foot” which is transcribed by the system 100 and displayed on, for example, display 114 as the word “soot”. The user can indicate or otherwise highlight the letter “s” in the word “soot”. When the speech recognition is activated the user may dictate the letter “f” which is recognized by the system 100 as an individual letter such that the letter “s” is replaced by the letter “f” in a manner substantially similar to that described above.

Referring again to FIG. 1, the system 100 of the disclosed embodiments can include input device 104, output device 106, process module 122, applications module 180, and storage/memory 182. The components described herein are merely exemplary and are not intended to encompass all components that can be included in the system 100. The device 100 can also include one or more processors to execute the processes, methods and instructions described herein. The processors can be stored in the device 100, or in alternate embodiments, remotely from the device 100.

The input device 104 is generally configured to allow a user to input data and commands to the system or device 100. The input device 104 may include any suitable input features including, but not limited to hard and/or soft keys 110 and touch/proximity screen 112. The output device 106 is configured to allow information and data to be presented to the user via the user interface 102 of the device 100. The process module 122 is generally configured to execute the processes and methods of the disclosed embodiments. The application process controller 132 can be configured to interface with the applications module 180 and execute applications processes with respect to the other modules of the system 100. The communication module 134 may be configured to allow the device to receive and send communications and messages, such as, for example, one or more of voice calls, text messages, chat messages and email. The communications module 134 is also configured to receive communications from other devices and systems.

The applications module 180 can include any one of a variety of applications or programs that may be installed, configured or accessible by the device 100. In one embodiment the applications module 180 can include text correction application 195, web browser, office, business, media player and multimedia applications. The applications or programs can be stored directly in the applications module 180 or accessible by the applications module. For example, in one embodiment, an application or program such as the text correction application 195 may be network based, and the applications module 180 includes the instructions and protocols to access the program/application and render the appropriate user interface and controls to the user.

In one embodiment, the system 100 comprises a mobile communication device. The mobile communication device can be Internet enabled. The input device 104 can also include a camera or such other image capturing system 113. In one aspect the imaging system 113 may be used to image any suitable text. The image of the text may be converted into, for example, an editable document (e.g. word processor text, email message, text message or any other suitable document) with, for example, an optical character recognition module 139. Any incorrectly recognized text in the converted text can be corrected in a manner substantially similar to that described above with respect to FIGS. 3A-4C. The applications 180 of the device may include, but are not limited to, data acquisition (e.g. image, video and sound), multimedia players (e.g. video and music players) and gaming, for example. In alternate embodiments, the system 100 can include other suitable devices, programs and applications.

While the input device 104 and output device 106 are shown as separate devices, in one embodiment, the input device 104 and output device 106 can be combined and be part of and form the user interface 102. The user interface 102 can be used to display information pertaining to content, control, inputs, objects and targets as described herein.

The display 114 of the system 100 can comprise any suitable display, such as a touch screen display, proximity screen device or graphical user interface. The type of display is not limited to any particular type or technology. In other alternate embodiments, the display may be any suitable display, such as for example a flat display 114 that is typically made of a liquid crystal display (LCD) with optional back lighting, such as a thin film transistor (TFT) matrix capable of displaying color images.

In one embodiment, the user interface of the disclosed embodiments can be implemented on or in a device that includes a touch screen display or a proximity screen device 112. In alternate embodiments, the aspects of the user interface disclosed herein could be embodied on any suitable device that will display information and allow the selection and activation of applications or system content. The terms “select”, “touch” and “indicate” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function, such as for example, selecting the text(s) to be corrected as described above.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

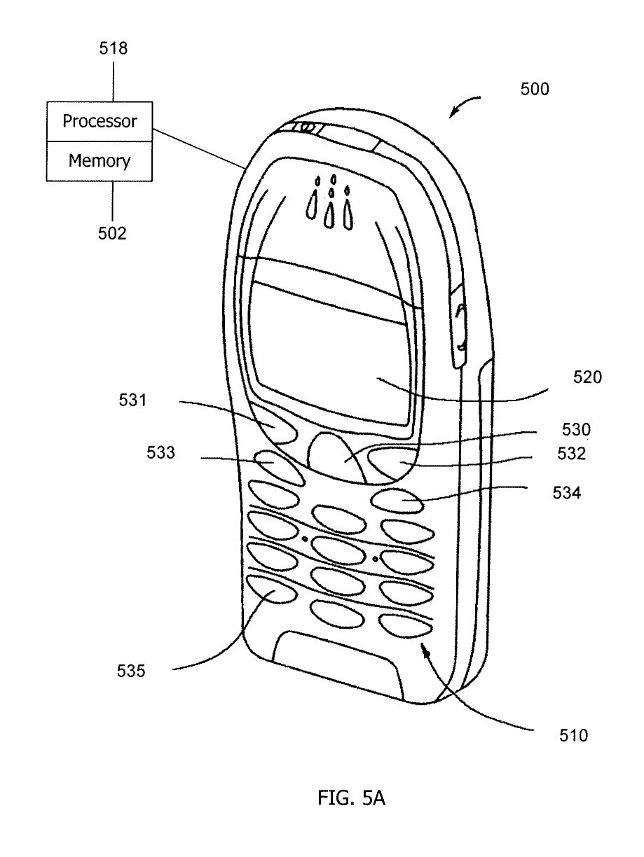

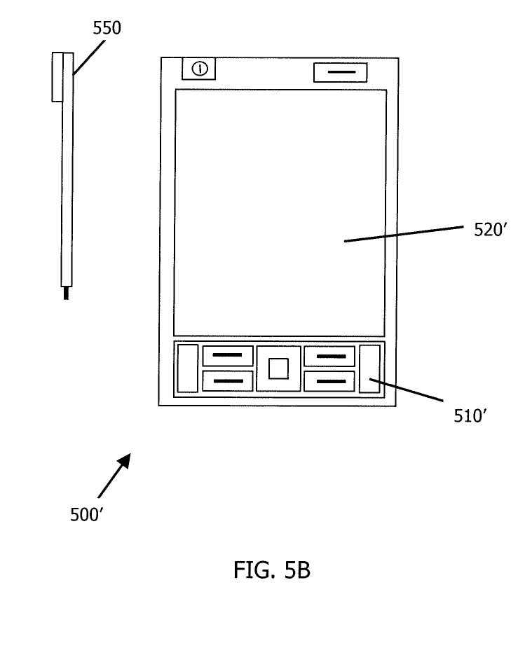

Some examples of devices on which aspects of the disclosed embodiments can be practiced are illustrated with respect to FIGS. 5A and 5B. The devices are merely exemplary and are not intended to encompass all possible devices or all aspects of devices on which the disclosed embodiments can be practiced. The aspects of the disclosed embodiments can rely on very basic capabilities of devices and their user interface. For example, in one aspect buttons or key inputs can be used for selecting the incorrect text as described above with respect to FIGS. 3A-4C.

As shown in FIG. 5A, in one embodiment, the terminal or mobile communications device 500 may have a keypad 510 as an input device and a display 520 for an output device. The keypad 510 may include any suitable user input devices such as, for example, a multi-function/scroll key 530, soft keys 531, 532, a call key 533, an end call key 534 and alphanumeric keys 535. In one embodiment, the device 500 may also include an image capture device substantially similar to image capture device 113 as a further input device. The display 520 may be any suitable display, such as for example, a touch screen display or graphical user interface. The display may be integral to the device 500 or the display may be a peripheral display connected or coupled to the device 500. A pointing device, such as for example, a stylus, pen or simply the user's finger may be used in conjunction with the display 520 for cursor movement, menu selection and other input and commands. In alternate embodiments any suitable pointing or touch device, or other navigation control may be used. In other alternate embodiments, the display may be a conventional display. The device 500 may also include other suitable features such as, for example a loud speaker, tactile feedback devices or connectivity port. The mobile communications device may have a processor 518 connected or coupled to the display for processing user inputs and displaying information on the display 520. A memory 502 may be connected to the processor 518 for storing any suitable information, data, settings and/or applications associated with the mobile communications device 500 such as those described above.

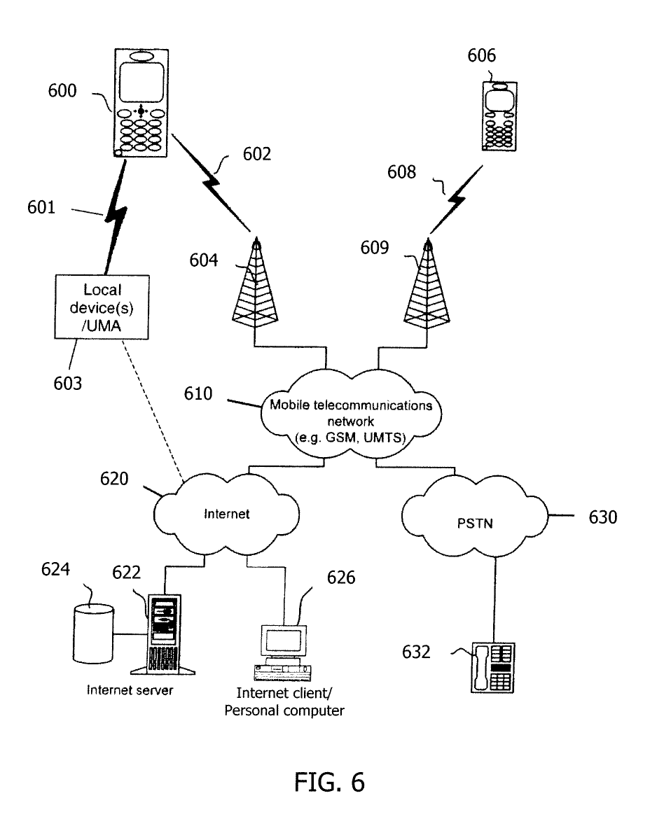

In the embodiment where the device 500 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 600 and other devices, such as another mobile terminal 606, a line telephone 632, an internet client/personal computer 626 and/or an internet server 622.

In one embodiment the system is configured to enable any one or combination of voice communication, chat messaging, instant messaging, text messaging and/or electronic mail. It is to be noted that for different embodiments of the mobile terminal 600 and in different situations, some of the telecommunications services indicated above may or may not be available. The aspects of the disclosed embodiments are not limited to any particular set of services or applications in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 610 may be operatively connected to a wide area network 620, which may be the Internet or a part thereof. A server, such as Internet server 622 can include data storage 624 and processing capability and is connected to the wide area network 620, as is an Internet client/personal computer 626. The server 622 may host a worldwide web/wireless application protocol server capable of serving worldwide web/wireless application protocol content to the mobile terminal 600.

A public switched telephone network (PSTN) 630 may be connected to the mobile telecommunications network 610 in a familiar manner. Various telephone terminals, including the stationary line telephone 632, may be connected to the public switched telephone network 630.

The mobile terminal 600 is also capable of communicating locally via a local link(s) 601 to one or more local devices 603. The local link(s) 601 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 603 can, for example, be various sensors that can communicate measurement values or other signals to the mobile terminal 600 over the local link 601. The above examples are not intended to be limiting, and any suitable type of link may be utilized. The local devices 603 may be antennas and supporting equipment forming a wireless local area network implementing Worldwide Interoperability for Microwave Access (WiMAX, IEEE 802.16), WiFi (IEEE 802.11lx) or other communication protocols. The wireless local area network may be connected to the Internet. The mobile terminal 600 may thus have multi-radio capability for connecting wirelessly using mobile communications network 610, wireless local area network or both. Communication with the mobile telecommunications network 610 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the communications module 134 is configured to interact with, and communicate to/from, the system described with respect to FIG. 6.

Although the above embodiments are described as being implemented on and with a mobile communication device, it will be understood that the disclosed embodiments can be practiced on any suitable device incorporating a display, processor, memory and supporting software or hardware. For example, the disclosed embodiments can be implemented on various types of music, gaming and/or multimedia devices with one or more communication capabilities as described above. In one embodiment, the system 100 of FIG. 1 may be for example, a personal digital assistant (PDA) style device 500′ illustrated in FIG. 5B. The personal digital assistant 500′ may have a keypad 510′, a touch screen display 520′, camera 521′ and a pointing device 550 for use on the touch screen display 520′. In still other alternate embodiments, the device may be a personal computer, a tablet computer, touch pad device, Internet tablet, a laptop computer, a mobile terminal, a cellular/mobile phone, a multimedia device, a personal communicator, a television set top box, a digital video/versatile disk (DVD) or High Definition disk recorder or any other suitable device capable of containing for example a display 114 shown in FIG. 1, and supported electronics such as the processor 518 and memory 502 of FIG. 5A. In one embodiment, these devices will be communication enabled over a wireless network.

The user interface 102 of FIG. 1 can also include menu systems 124 coupled to the process module 122 for allowing user input and commands such as those described herein. The process module 122 provides for the control of certain processes of the system 100 including, but not limited to the controls for speech recognition and text correction. The menu system 124 can provide for the selection of different tools and application options related to the applications or programs running on the system 100 in accordance with the disclosed embodiments. The menu system 124 may also provide for configuring the text correction module 138/application 195 as described above. In the embodiments disclosed herein, the process module 122 receives certain inputs, such as for example, signals, transmissions, instructions or commands related to the functions of the system 100. Depending on the inputs, the process module 122 interprets the commands and directs the process control 132 to execute the commands accordingly in conjunction with the other modules and/or applications, such as for example, speech recognition module 137, text correction module 138, communication module 134 and text correction application 195. In accordance with the embodiments described herein, this can include correcting any suitable text input into the system 100.

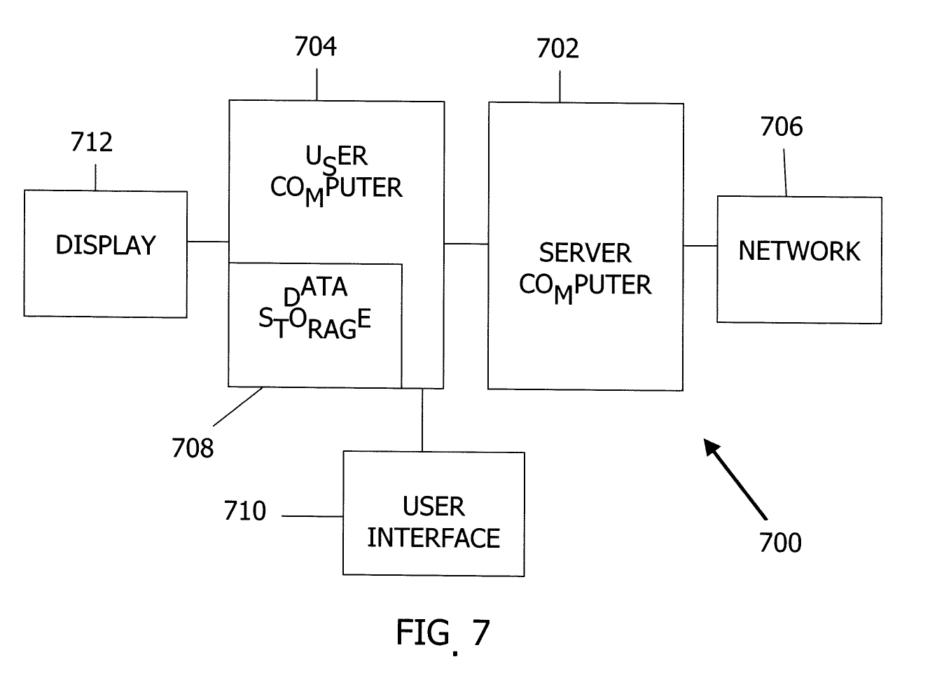

The disclosed embodiments may also include software and computer programs incorporating the process steps and instructions described above. In one embodiment, the programs incorporating the process steps described herein can be stored on and/or executed in one or more computers. FIG. 7 is a block diagram of one embodiment of a typical apparatus 700 incorporating features that may be used to practice aspects of the disclosed embodiments. The apparatus 700 can include computer readable program code means for carrying out and executing the process steps described herein. In one embodiment the computer readable program code is stored in a memory of the device. In alternate embodiments the computer readable program code can be stored in memory or a memory medium that is external to, or remote from, the apparatus 700. The memory can be directly coupled or wirelessly coupled to the apparatus 700. As shown, a computer system 702 may be linked to another computer system 704, such that the computers 702 and 704 are capable of sending information to each other and receiving information from each other. In one embodiment, computer system 702 could include a server computer adapted to communicate with a network 706. Alternatively, where only one computer system is used, such as computer 704, computer 704 will be configured to communicate with and interact with the network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or through a dial-up connection on an integrated services digital network (ISDN) line or other such communication channel or link. In one embodiment, the communication channel comprises a suitable broad-band communication channel. Computers 702 and 704 are generally adapted to utilize program storage devices embodying machine-readable program source code, which is adapted to cause the computers 702 and 704 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks, memory sticks, flash memory devices and other semiconductor devices, materials and chips.

Computer systems 702 and 704 may also include a microprocessor for executing stored programs. Computer 702 may include a data storage device 708 on its program storage device for the storage of information and data. The computer program or software incorporating the processes and method steps incorporating aspects of the disclosed embodiments may be stored in one or more computers 702 and 704 on an otherwise conventional program storage device. In one embodiment, computers 702 and 704 may include a user interface 710, and/or a display interface 712 from which aspects of the disclosed embodiments can be accessed. The user interface 710 and the display interface 712, which in one embodiment can comprise a single interface, can be adapted to allow the input of queries and commands to the system, as well as present the results of the commands and queries, as described with reference to FIGS. 1 and 3A-4C for example.

The aspects of the disclosed embodiments are directed to improving how corrections are made to text input in a device using automatic speech recognition. Aspects of the disclosed embodiments provide for selecting incorrectly transcribed adjacent and non-adjacent pieces of text for correction where all of the indicated pieces of text are corrected with one activation of the speech recognition module/application. Aspects of the disclosed embodiments also provide for the correction/replacement of a single word with multiple words and vice versa. The disclosed embodiments effectively avoid having to initiate the speech recognition module/application for each piece of text to be corrected saving the user time and decreasing the number of key presses needed to make the corrections.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting a selection of a plurality of erroneous words in text presented on a display of a device;
in an automatic speech recognition system, receiving sequentially dictated corrections for the selected erroneous words in a single, continuous operation where each dictated correction corresponds to at least one of the selected erroneous words; and
replacing the plurality of erroneous words with one or more corresponding words of the dictated corrections where each erroneous word is matched with the one or more corresponding words of the dictated corrections in an order the erroneous words appear according to a reading direction of the text.

2. The method of claim 1, wherein the plurality of erroneous words includes non-adjacent words.

3. The method of claim 1, further comprising acquiring the text in the device through speech recognition.

4. The method of claim 1, wherein the text is computer readable text resident in a memory of the device.

5. The method of claim 1, wherein selecting the plurality of erroneous words includes selecting each erroneous word with a pointing device of a touch or proximity sensitive device.

6. The method of claim 1, wherein the plurality of erroneous words are selected automatically.

7. The method of claim 1, wherein replacing a last one of the plurality of erroneous words comprises replacing the last one of the plurality of erroneous words with extra dictated corrections when a number of dictated corrections is greater than a number of erroneous words.

8. The method of claim 1, further comprising ignoring remaining ones of the plurality of erroneous words where a number of dictated corrections is less than a number of erroneous words.

9. The method of claim 1, wherein one or more erroneous words are matched with a corresponding one or more of the dictated corrections based on acoustic model comparisons.

10. The method of claim 1, wherein one or more erroneous words are matched with a corresponding one or more of the dictated corrections based on textual similarities.

11. The method of claim 1, wherein one or more erroneous words are matched with one or more of the dictated corrections based on linguistic plausibility.

12. The method of claim 1, wherein one or more erroneous words are matched with one or more of the dictated corrections based on detection of an actuation of a key of the device or through guidance by the device.

13. A computer program product stored in a memory comprising computer readable program code embodied in a computer readable medium for:
detecting a selection of a plurality of erroneous words in text presented on a display of a device;
in an automatic speech recognition system, sequentially receiving a dictated correction for the selected erroneous words in a single, continuous operation where each dictated correction corresponds to at least one of the selected erroneous words; and
replacing the plurality of erroneous words with one or more corresponding words of the dictated corrections where each erroneous word is matched with the one or more corresponding words of the dictated corrections in an order the erroneous words appear according to a reading direction of the text.

14. The computer program product of claim 13, wherein the computer readable program code is stored in a memory of a mobile communications device.

15. An apparatus comprising:
a display; and
a processor configured to
detect a selection of a plurality of erroneous words in text presented on the display,
receive, through an automatic speech recognition module, sequentially dictated corrections for the selected erroneous words in a single, continuous operation where each dictated correction corresponds to at least one of the selected erroneous words, and
replace the plurality of erroneous words with one or more corresponding words of the dictated corrections where each erroneous word is matched with the one or more corresponding words of the dictated corrections in an order the erroneous words appear according to a reading direction of the text.

16. The apparatus of claim 15, wherein the plurality of erroneous words includes non-adjacent words.

17. The apparatus of claim 15, wherein the processor is further configured to acquire the text in the apparatus through speech recognition.

18. The apparatus of claim 15, wherein the text is computer readable text resident in a memory of the apparatus.

19. The apparatus of claim 15, further comprising a touch or proximity sensitive module configured for selecting each erroneous word.

20. The apparatus of claim 15, wherein the processor is further configured to automatically select the plurality of erroneous words.

21. The apparatus of claim 15, wherein the processor is further configured to replace a last one of the plurality of erroneous words with extra dictated corrections when a number of dictated corrections is greater than a number of erroneous words.

22. The apparatus of claim 15, wherein the processor is further configured to ignore remaining ones of the plurality of erroneous words where a number of dictated corrections is less than a number of erroneous words.

23. The apparatus of claim 15, wherein the apparatus comprises a mobile communication device.

24. A user interface comprising:
a display configured to display computer readable text;
at least one input device configured to receive sequentially dictated corrections through automatic speech recognition for replacing a plurality of selected erroneous words in a single, continuous operation where each dictated correction corresponds to at least one of the selected erroneous words; and
a processor being configured to
detect a selection of the plurality of erroneous words in the computer readable text presented on the display, and
replace the plurality of erroneous words with one or more corresponding words of the dictated corrections where each erroneous word is matched with the one or more corresponding words of the dictated corrections in an order the erroneous words appear according to a reading direction of the text.

25. The user interface of claim 24, wherein the plurality of erroneous words includes non-adjacent words.

26. The user interface of claim 24, wherein the text is computer readable text resident in a memory of the user interface or is acquired through the automatic speech recognition.

27. The user interface of claim 24, wherein the processor is further configured to replace a last one of the plurality of erroneous words with extra dictated corrections when a number of dictated corrections is greater than a number of erroneous words.

28. The user interface of claim 24, wherein the processor is further configured to ignore remaining ones of the plurality of erroneous words where a number of dictated corrections is less than a number of erroneous words.
